(19) United States
(12) Patent Application Publication
(10) Pub. No.: US 2015/0237578 A1
(43) Pub. Date: Aug. 20, 2015

(54) ACCESS POINT POWER SAVE ENHANCEMENTS

(71) Applicants: SHANTANU ARUN GOGATE, Erandwane (IN); Sandesh Goel, Noida (IN); Rajesh Shreeram Bhagwat, San Jose, CA (US)

(72) Inventors: SHANTANU ARUN GOGATE, Erandwane (IN); Sandesh Goel, Noida (IN); Rajesh Shreeram Bhagwat, San Jose, CA (US)

(21) Appl. No.: 12/877,564

(22) Filed: Sep. 8, 2010

Related U.S. Application Data
(63) Continuation-in-part of application No. 12/435,871, filed on May 5, 2009, now Pat. No. 9,055,531.
(60) Provisional application No. 61/243,077, filed on Sep. 16, 2009.
(60) Provisional application No. 61/249,149, filed on Oct. 6, 2009.
(60) Provisional application No. 61/118,727, filed on Dec. 1, 2008.

(51) Int. Cl. H04W 52/02; H04B 7/00

(52) U.S. Cl. CPC H04W 52/0225; H04W 52/0235

(57) ABSTRACT

Activity-based power saving for a wireless communication device includes operating the wireless communication device in a first power mode. An activity in a basic service set of the wireless communication device is monitored while the wireless communication device operates in the first power mode. The wireless communication device is operated in a second power mode in response to the activity in the basic service set satisfying a first pre-determined condition while the wireless communication device operates in the first power mode. The activity in the basic service set is monitored while the wireless communication device operates in the second power mode. The wireless communication device is operated in a third power mode in response to the activity in the basic service set continuously satisfying the first pre-determined condition while the wireless communication device operates in the second power mode.

### CROSS-REFERENCE TO PRIOR APPLICATIONS

This application claims the benefit of U.S. Provisional Application No. 61/249,149, filed Oct. 6, 2009 and U.S. Provisional Application No. 61/243,077, filed Sep. 16, 2009, which are both hereby incorporated by reference for all purposes as if fully set forth herein. Further, this application is a continuation-in-part of prior application Ser. No. 12/435,871, filed May 5, 2009, which claims the benefit of U.S. Provisional No. 61/118,727, filed Dec. 1, 2008, which are both hereby incorporated by reference for all purposes as if fully set forth herein.

### BACKGROUND OF THE DISCLOSURE

1. Field of the Disclosure

This disclosure is directed to an access point, and more particularly to enhancing an access point to consume less power and/or require less memory.

2. Related Art

A wireless access point connects various wireless communication devices associated thereto to a wireless network, and relays data to and/or from the associated wireless communication devices. For example, the wireless communication devices, such as, for example, computers, printers, data storage, audio/video devices, and/or the like, may be connected to an access point directly or indirectly, and may exchange data with each other. Thus, the wireless access point is a very popular choice for implementing a network, such as, e.g., home wireless network and the like. Currently, many of the wireless access points on the market are stationary access points, which require an external source and, hence, might not be used when no power source is available. Portable access points typically include an internal power source, such as, e.g., a rechargeable battery, to power the device when no external power source is available.

### SUMMARY OF THE DISCLOSURE

In one aspect of the disclosure, an activity-based power saving method for a wireless communication device includes operating the wireless communication device in a first power mode, monitoring an activity in a basic service set of the wireless communication device while the wireless communication device operates in the first power mode, operating the wireless communication device in a second power mode in response to the activity in the basic service set satisfying a first pre-determined condition while the wireless communication device operates in the first power mode, monitoring the activity in the basic service set while the wireless communication device operates in the second power mode, and operating the wireless communication device in a third power mode in response to the activity in the basic service set continuously satisfying the first pre-determined condition while the wireless communication device operates in the second power mode.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a wireless local area network (WLAN) configuration employing an access point, constructed according to an aspect of the disclosure;

FIG. 2 shows an example of a configuration of the access point shown in FIG. 1, constructed according to an aspect of the disclosure;

FIG. 3 shows a flow chart of a process for adjusting a clock frequency of a controller of an access point, according to an aspect of the disclosure;

FIG. 4 shows a flow chart of a process for adjusting a transmit power of an access point, according to an aspect of the disclosure;

FIG. 5 shows a flow chart of a process for activating a sleep mode in an access point, according to an aspect of the disclosure;

FIG. 6 shows a flow chart of a process for suspending an associated station from sending data traffic to an access point in a sleep mode, according to an aspect of the disclosure;

FIG. 7 shows a flow chart of a process for reducing an impact on another basic service set (BSS) when an access point suspends an associated station from sending data traffic, according to an aspect of the disclosure;

FIG. 8 shows a flow chart of a process for operating an access point to handle unicast data traffic, according to an aspect of the disclosure;

FIG. 9A shows a timing diagram showing an example of power consumption by an access point operating the process of FIG. 5 according to an aspect of the disclosure;

FIG. 9B shows a timing diagram showing an example of activities in a basic service set (BSS) during the same period time as FIG. 9A according to an aspect of the disclosure;

FIG. 10 shows another wireless local area network (WLAN) configuration including a plurality of BSSs overlapping each other;

FIG. 11 shows another configuration of an access point constructed according to an aspect of the disclosure;

FIG. 12 shows a flow chart of a comprehensive power save method for an access point according to an aspect of the disclosure;

FIG. 13 shows a flow chart of an activity-based power save process for an access point according to an aspect of the disclosure; and

FIG. 14 shows a timing diagram showing BSS activities and access point power consumption according to an aspect of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

The disclosure is directed to enhancing performance of an access point (AP), which is typically used to connect one or more stations associated thereto to a wired and/or wireless network. The access point and associated remote stations may constitute a basic service set (BSS). The AP performance may be enhanced by monitoring one or more indicative parameters of the BSS and adjusting one or more operational AP parameters based on the one or more indicative BSS parameters. The indicative BSS parameters may include, for example, but are not limited to, an amount of data traffic flowing through the access point, proximity of the associated station to the access point, an activity level in the BSS, a reaction of the associated stations regarding data destined thereto and buffered at the access point, and/or the like. The operational AP parameters may include, for example, but are not limited to, a clock frequency of the access point, a transmit power of the access point, an operational mode of the access point, an occupancy of a buffer of the access point configured to buffer data destined to the associated station, and/or the like.

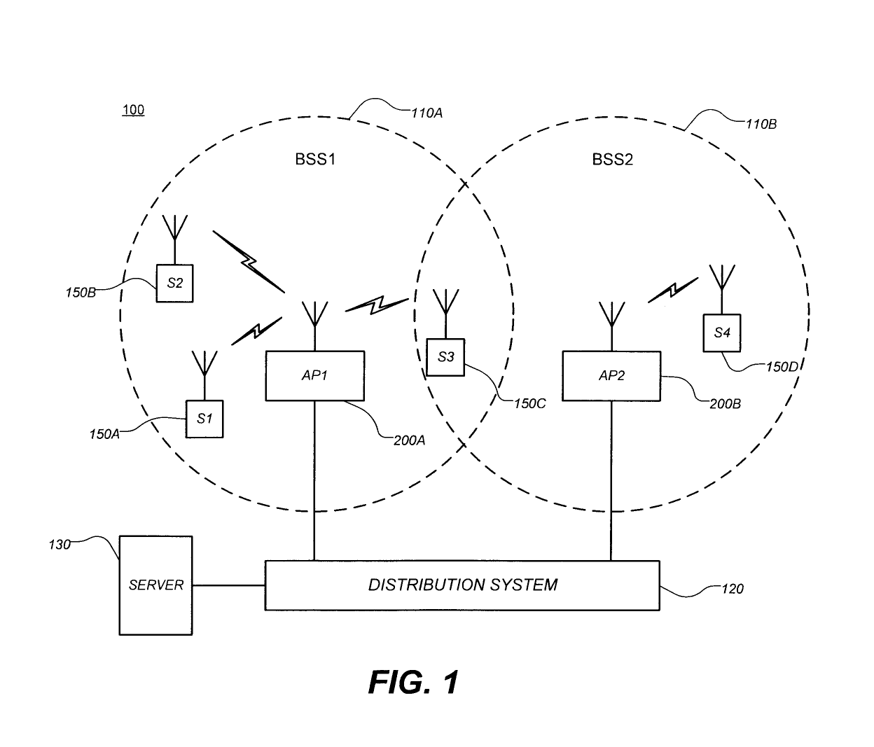

FIG. 1 shows a configuration of a wireless local area network (WLAN) 100 constructed according to an aspect of the disclosure. The WLAN 100 includes one or more basic service sets (BSS), such as, e.g., a first BSS (BSS1) 110A, a second BSS (BSS2) 110B and/or the like. The first BSS 110A includes a first access point (AP1) 200A, one or more stations 150 (e.g., a first station 150A (S1), a second station 150B (S2), a third station (S3) 150C and/or the like) that are currently associated to the first access point 200A and/or the like. The first access point 200A connects the associated stations 150A, 150B, 150C to a wireless network within the first BSS 110A. The second BSS 110B includes a second access point (AP2) 200B, one or more stations (e.g., a fourth station (S4) 150D and/or the like) associated to the second access point 200B and/or the like. The second access point 200B connects the associated station 150D to a wireless network within the second BSS 110B. Certain stations, such as, e.g., the third station 150C, may be located in an area where the first BSS 110A and second BSS 110B overlap. In this case, the third station 150C may be associated with either of the access points 200A, 200B although FIG. 1 shows the third station 150C associated with the first access point 200A.

The access points 200A, 200B are connected to a distribution system 120, which may be a wired LAN or the like and configured to interconnect the access points, such as, e.g., the access points 200A, 200B of the WLAN 100. The distribution system 120 is connected to a server 130 or other networks, such as, e.g., the Internet (not shown), extranet (not shown) or the like. The distribution system 120 allows any two or more stations, for example, the stations 150A and 150D, connected to two different access points, for example, the access points 200A, 200B, to communicate with each other. Further, the distribution system 120 allows any station (such as, e.g., stations 150A, 150B, 150C or 150D) within the WLAN 100 to communicate with other entities, such as, e.g., stations associated to other WLAN, LAN or the like, that is connected to the WLAN 100.

In the WLAN 100, one or more of the access points 200A, 200B are configured with enhanced features, such as, e.g., reduced power consumption, reduced memory requirement and/or the like. Although, in the WLAN 100 shown in FIG. 1, only the first access point 200A is configured with one or more enhanced features, any number of the access points in the WLAN 100 may be configured with the enhancements. The first access point 200A may be a portable access point configured with an internal power source (such as, e.g., a rechargeable battery, a solar cell array, or the like). By reducing power consumption, any portable access point (such as, e.g., the access points 200A, 200B) may substantially extend its battery life. Even if the first access point 200A is stationary and connected to a power source, the first access point 200A may benefit from reduced power consumption due to the increasing environmental and economical constraints on energy consumption. The reduced memory requirement may also be advantageous because the first access point 200A may be configured in a smaller housing or package, which may be particularly beneficial to portable access points. Furthermore, manufacturing costs may be reduced, since, e.g., less memory is needed.

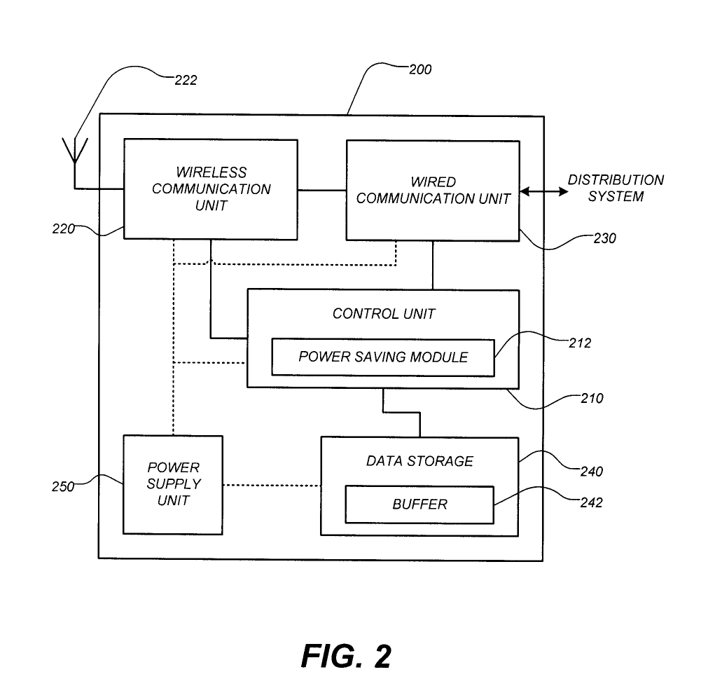

FIG. 2 shows an example configuration of an access point 200, constructed according to an aspect of the disclosure. The access point 200 may be used as the first access point 200A shown in FIG. 1. The access point 200 includes a control unit 210, a wireless communication unit 220, a wired communication unit 230, a data storage unit 240, a power supply unit 250 and/or the like. The control unit 210 may be configured to control an overall operation of the access point 200, including operations related to reducing power consumption and/or operations requiring less memory. For example, the control unit 210 includes a power saving module 212 to operate the access point 200 with reduced power consumption. The control unit 210 may include a microprocessor, a microcontroller, or the like, which may be configured to execute instructions of a computer program stored in a machine readable storage medium. The instructions may include instructions for carrying out the power saving schemes. The control unit 210 may store the computer program embodying the instructions in its internal data storage (not shown), such as, e.g., an embedded read only memory (ROM), or the like, or, alternatively, in the data storage unit 240.

The wireless communication unit 220, which includes an antenna 222, may exchange data streams with the stations 150A, 150B, 150C (shown in FIG. 1) wirelessly via a specific radio frequency. The wired communication unit 230 is connected to the distribution system 120 (shown in FIG. 1) and processes data traffic between the access point 200 and the distribution system 120. The data storage unit 240 may temporarily store data that is sent to and from the associated stations 150A, 150B, 150C. For example, in one implementation, the data storage unit 240 includes a buffer 242 for temporarily storing the data bound to the stations 150A, 150B, 150C, as well as data received from the stations 150A, 150B, 150C to be processed by the access point 200. The power supply unit 250 may be connected to the control unit 210, the wireless communication unit 220, the wired communication unit 230, the data storage unit 240 and/or the like, to supply power thereto. The power supply unit 250 may include a rechargeable battery, a non-rechargeable battery, an array of solar cells, a wired power supply configured to receive power from an external AC or DC power supply source, or the like.

The operations related to reducing power consumption may include scaling a clock frequency of the control unit 210, adjusting transmit power of the wireless communication unit 220, efficiently activating a sleep mode, and/or the like. Regarding the clock frequency scaling, active periods of the access point 200 are typically interleaved with relatively longer inactive periods. Thus, substantial reduction in power consumption may be achieved by scaling the clock frequency of the control unit 210 when the access point 200 is not active. For example, the control unit 210 can operate at a lower clock frequency when no station is associated to the access point 200; none of the associated stations 150A, 150B, 150C is active, and/or the like. To achieve this, the access point 200 can be configured to adjust the clock frequency of the control unit 210 depending on a degree of the data traffic passing through the access point 200. The access point 200 may periodically determine an amount of data traffic flowing through the access point. Then, the access point 200 may lower the clock frequency of the control unit 210 when the amount of data traffic is reduced. In an aspect, the control unit 210 can be configured to dynamically scale the clock frequency to the amount of the data traffic. Alternatively, the control unit 210 may be provided with one or more threshold data traffic amount values and/or ranges and compare the amount of data traffic to the threshold values and/or ranges to determine an appropriate clock frequency for the amount of the data traffic.

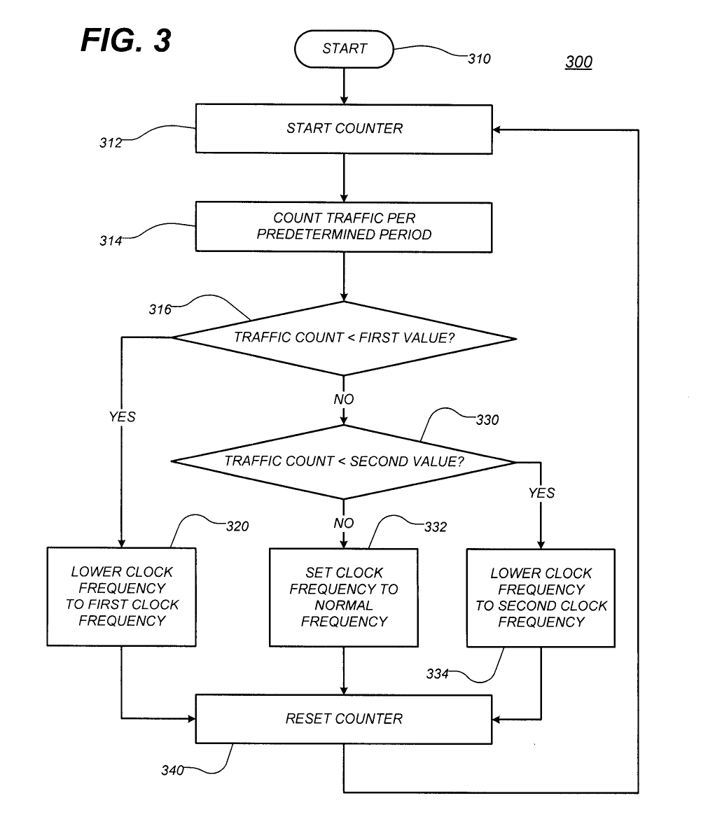

For example, FIG. 3 shows a flow chart of a process 300 for adjusting a clock frequency of a controller (such as, e.g., the control unit 210 shown in FIG. 2) of an access point, according to an aspect of the disclosure. Upon starting the process at step 310, the access point starts or initializes a counter for a predetermined period of time (e.g., 1 second) at step 312. Then, the access point determines an amount of data traffic passing through the access point during the predetermined period of time at step 314. The determined amount of data traffic is then compared to a first predetermined threshold value (e.g., 1000 bytes or 1 packet per second) at step 316. The threshold value may be in terms of bytes, a number of packets and/or a combination of both bytes and a packet number. When the amount of data traffic during the predetermined period of time is smaller than the first predetermined threshold value at step 316, the clock frequency of the controller is lowered to a first clock frequency (e.g., 5 MHz), which may substantially reduce power consumption by the controller.

For more precise scaling of the clock frequency, more than one predetermined threshold value may be used. For example, when the amount of data traffic during the predetermined period of time is greater than the first predetermined threshold value at step 316, the amount of data traffic can be compared to a second predetermined threshold value (e.g., 100 Kbytes or 100 packets per second), which may be higher than the first predetermined threshold value, at step 330. When the amount of data traffic is smaller than the second predetermined threshold value at step 330, the clock frequency of the controller is lowered to a second clock frequency (e.g., 40 MHz) at step 334. The second clock frequency may be higher than the first clock frequency but lower than a normal clock frequency (e.g., 128 MHz) of the controller. When the amount of data traffic is greater than the second predetermined threshold value, the controller sets or maintains a normal clock frequency at step 332. Once the clock frequency of the controller is adjusted or maintained at steps 320, 332, 334, the access point can reset the counter at step 340, and the process may loop back to starting the counter at step 312. Alternatively, the process 300 may end.

Although FIG. 3 shows only two predetermined threshold values for comparison with the amount of the data traffic passing through the access point, the number of threshold values might not be limited thereto and more than two threshold values may be used. Alternatively, the clock frequency of the controller can be adjusted proportionally to the amount of the data traffic passing through the access point. For example, the controller may initially operate at a low or the lowest clock frequency but later operate at a higher clock frequency as the amount of the data traffic increases. Alternatively, the controller may operate at a middle frequency but later operate at higher or lower frequencies depending on the data traffic amount.

Additionally or alternatively, an access point can be configured to reduce the power consumption by adjusting a transmit power of the access point. More specifically, the access point may adjust the transmit power depending on proximity (or distance) of stations associated thereto. For example, in FIG. 1, when all the associated stations 150A, 150B, 150C are located close to the access point 200, the access point 200 can reduce the transmit power of the access point 200, which may reduce the power consumption of the access point 200.

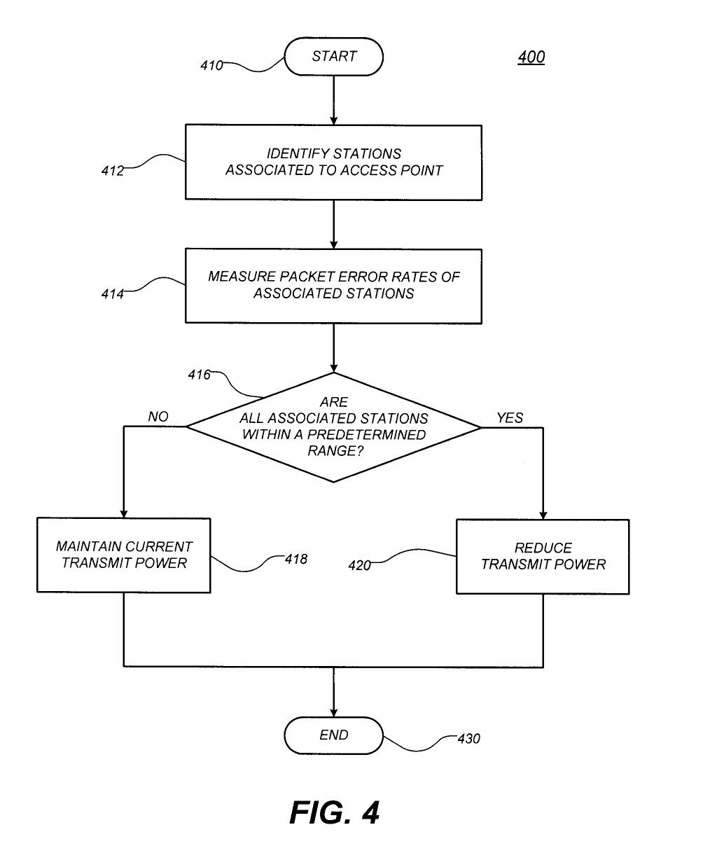

FIG. 4 shows a flow chart of a process 400 for adjusting a transmit power of an access point, according to an aspect of the disclosure. Upon starting the process at step 410, an access point identifies stations that are associated thereto at step 412. Then, the access point determines proximity of the associated stations. For example, the access point can use transmit power control (TPC) algorithm, which is typically used to prevent undesirable interferences between two or more neighboring BSSs. The access point measures a packet error rate (PER) of each associated station, as known in the art, at step 414. Based on the PER of each station, the access point can determine whether each station is within a predetermined range from the access point. For example, when the PER of each associated station is lower than a predetermined threshold value (e.g., about 10%), the access point can determine that all the associated stations are within a predetermined range and reduce the transmit power at step 420. Other methods may be used to determine whether the associated stations are within a predetermined range. When one or more associated stations are located outside the predetermined range at step 416, the access point can maintain the normal transmit power at step 418. Upon completing step 418 or step 420, the process 400 may terminate at step 430.

The process 400 can be repeated periodically to more aggressively attempt to reduce power consumption. Furthermore, more than one predetermined range may be used to more precisely scale the transmit power depending on proximity of the associated stations. Additionally, an inverse operation can be performed at steps 416 and 420. That is, if it is determined that all of the associated stations have moved away from the access point (step 416), beyond a predetermined range, then the transmit power can be increased by a predetermined value (step 420).

Another effective way to reduce power consumption is to effectively activate a sleep mode in an access point since an access point typically consumes a minimum amount of power during the sleep mode. However, it may be necessary to ensure that there is no active traffic in a BSS to which the access point belongs. This may be achieved in several different ways, including, for example, a clear-to-send (CTS) based sleep mode, a contention free period based sleep mode, a quiet period based sleep mode and/or the like.

In the CTS based sleep mode, an access point (such as, e.g., the access point 200 in FIG. 1) can send a CTS-to-self frame to prevent stations (such as, e.g., the stations 150A, 150B, 150C in FIG. 1) within a pre-determined range of the access point from sending any data to the access point. Then the access point may enter a sleep mode for a predetermined duration (i.e., sleep duration) specified in the CTS-to-self frame. The maximum sleep duration can be equal to a maximum duration that may be designated in the CTS-to-self frame, which may be, for example, about 32 ms. However, the access point may determine the actual sleep duration based on a level of activity in the BSS. More specifically, the access point can keep track of a percentage of time that the access point is transmitting over the BSS, which is commonly referred to as medium occupancy, and can enter the sleep mode only for an amount of time when the BSS is expected to remain idle. This may be continuously adapted by tracking medium occupancy in the BSS periodically.

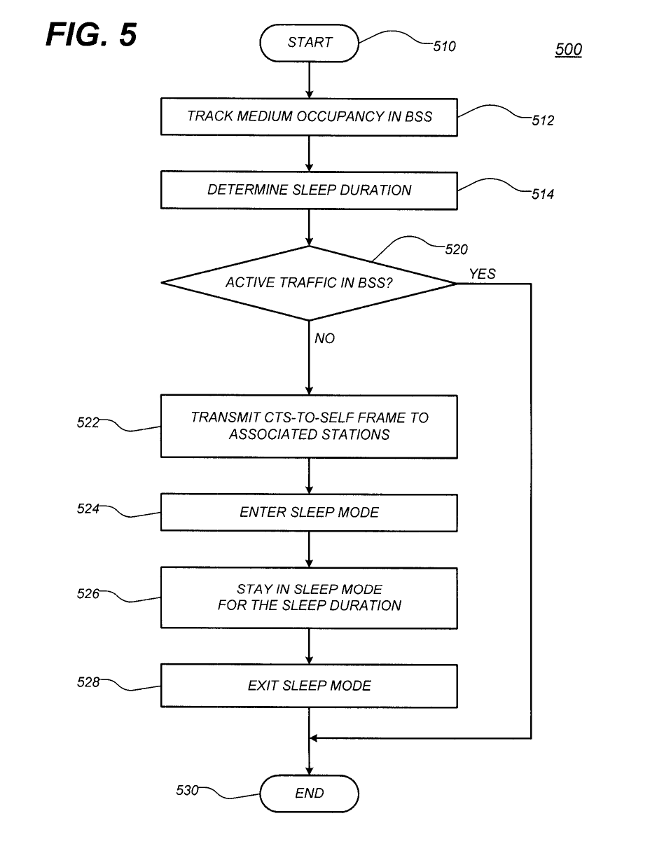

FIG. 5 shows a flow chart of a process 500 for operating the CTS-based sleep mode in an access point, according to an aspect of the disclosure. Upon starting the process 500 at step 510, the access point tracks medium occupancy of its BSS at step 512. Then, the access point determines a sleep duration at step 514 based on the medium occupancy of the BSS obtained at step 512. When it is determined that there is active data traffic in the BSS at step 520, the access point takes no action to enter the sleep mode and the process 500 may terminate at step 530. However, when it is determined that there is no active data traffic in the BSS at step 520, the access point transmits a CTS-to-self frame at step 522. The CTS-to-self frame can include the sleep duration determined at step 514. Upon receiving the CTS-to-self frame, the associated stations do not send data to the access point during the sleep duration specified in the CTS-to-self frame. Then, the access point enters the sleep mode at step 524, and remains in the sleep mode for the sleep duration at step 526. The access point wakes up when the sleep duration lapses at step 528 and the process 500 terminates at step 530.

As an alternative to the (CTS) based sleep mode operation, a contention free period (CFP) based sleep mode operation, a quiet period based sleep mode operation and/or the like can be used to operate the access point with reduced power consumption. In the CFP based sleep mode operation, the access point advertises a contention free period in its beacons, which prevents the associated stations from sending data traffic during the contention free period. Thus, the access point can safely enter and stay in the sleep mode during the contention free period. More specifically, an exact duration of the contention free period can be advertised in a MaxCFPDuration field in the beacon. The CFP based sleep mode operation can be executed based on the activities in the BSS, which is similar to the CTS based sleep mode operation shown in FIG. 5. Similarly, in the quiet period based sleep mode operation, the access point can also send quiet information element (IE) as part of a beacon to the associated stations in order to periodically silence the associated stations for a predetermined period of time before entering and staying in a sleep mode for the predetermined period of time.

To operate the CTS based sleep mode successfully, it may be necessary to ensure that all of the associated stations are not in a sleep mode when the access point transmits the CTS-to-self frame. Otherwise, should an associated station be in a sleep mode during the time that the access point transmits the CTS-to-self frame, the associated station may to receive the CTS-to-self frame. In such a circumstance, upon waking up, the associated station may try to send data to the access point while the access point is in a sleep mode. To avoid this situation, the access point can send the CTS-to-self frame immediately after sending a delivery traffic indication message (DTIM) to ensure that the associated stations are not in the sleep mode and, hence, will receive the CTS-to-self frame.

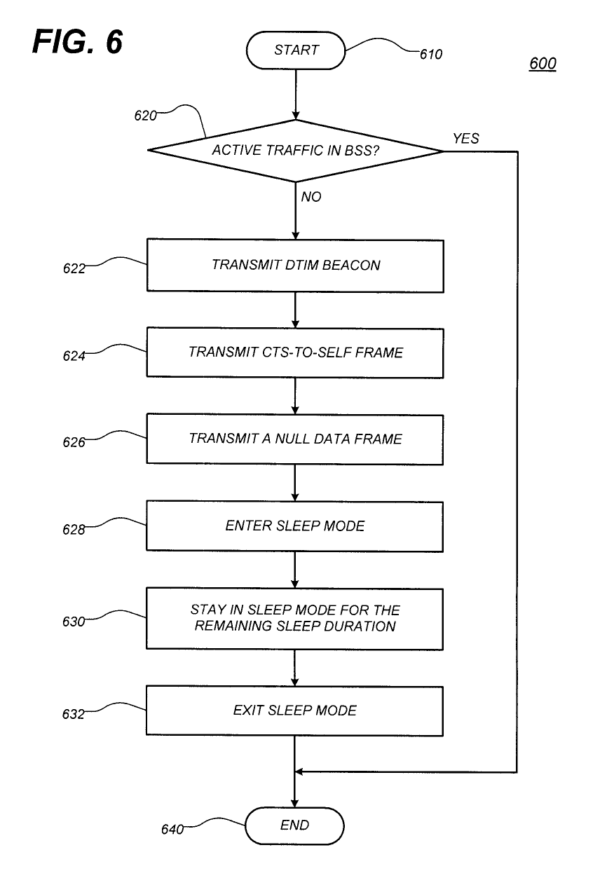

FIG. 6 shows a flow chart of a process 600 for suspending the associated stations from sending data to an access point, according to an aspect of the disclosure. The process 600 can be performed in connection with the process 500 shown in FIG. 5. Upon starting the process 600 at step 610, the access point monitors activities in the BSS at step 620. If it is determined that there is active data traffic in the BSS at step 620, the process 600 terminates at step 640. When it is determined that there is no active data traffic in the BSS at step 620, the access point transmits a DTIM beacon to the associated stations. More specifically, the access point, e.g., sets a broadcast DTIM flag to 1 in the DTIM beacon to ensure that any associated stations in the sleep mode stay awake to receive data that is subsequently transmitted from the access point. After transmitting the DTIM beacon at step 622, the access point transmits the CTS-to-self frame to the associated stations to ensure that the associated stations do not send any data to the access point during the sleep duration specified in the CTS-to-self frame. Optionally, the access point can transmit a broadcast null data frame to the associated stations at step 626, in order to allow the associated stations to enter the sleep mode. To achieve this, the broadcast null data frame can be transmitted with the “more” data bit cleared.

Once the CTS-to-self frame is transmitted at step 624, the access point enters a sleep mode at step 628 and stay in the sleep mode for the remaining portion of the sleep duration specified in the CTS-to-self frame at step 630. The access point wakes up when the sleep duration has lapsed at step 632 and the process 600 terminates at step 640.

When one or more of the associated stations are in the sleep mode, the access point enters the sleep mode at most once per DTIM interval. Thus, the process 600 can be particularly useful when the DTIM period is relatively low, for example, when a DTIM interval is around 35 ms (e.g., beacon interval=35 ms, DTIM period=1). In this case, the access point may take advantage of the process 600 to stay powered down for a maximum 90% of the total DTIM period, unless it is determined that there is active traffic in the BSS at step 620. Even with a commonly used beacon interval of 100 ms, the process 600 may achieve, e.g., about 30% power savings.

The CTS-based sleep mode operation shown in FIG. 5 can cause undesirable interference on an overlapping or neighboring BSS. For example, in FIG. 1, the CTS-based sleep mode operation performed in the first BSS 110A can interfere with operations of the second BSS 110B. More specifically, upon receiving the CTS-to-self frame from the first access point 200A of the first BSS 110A, the second access point 200B and/or the forth station 150D in the second BSS 110B can also stop sending data during the sleep duration in the CTS-to-self frame. Thus, when performing the CTS-based sleep mode operation, it may be necessary to reduce or minimize the interference on an overlapping or neighboring BSS. This can be achieved by transmitting the CTS-to-self frame at an optimal transmit power, which is strong enough to reach all the associated stations but not strong enough to reach an access point and/or stations in an overlapping or neighboring BSS.

In an aspect, an access point sequentially transmits request-to-send (RTS) frames at gradually increased transmit power levels, preferably starting from a lowest transmit power level, until the access point successfully receives responses from all the stations associated thereto. The RTS frame indicates that the access point is ready to send data. Thus, even if it reaches an overlapping or neighboring BSS, the impact on the overlapping or neighboring BSS is relatively smaller compared to the impact a CTS-to-self frame may have on the BSS. Once the successful responses are received from all the associated stations, the access point can transmit a CTS-to-self frame at the power level the RTS frames were transmitted when all the associated stations have responded.

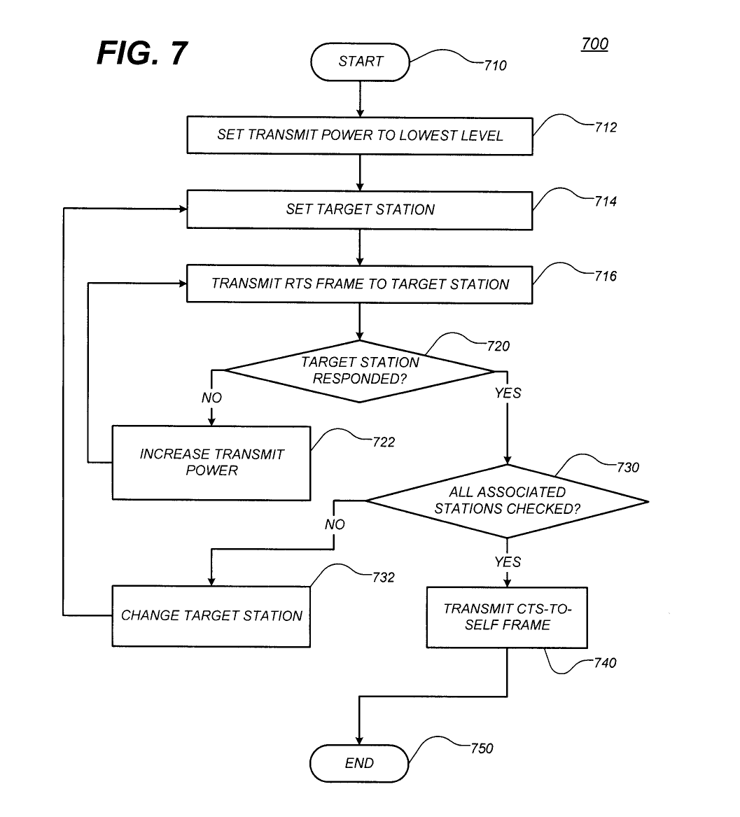

FIG. 7 shows a flow chart of a process 700 for reducing an impact on another basic service set (BSS) when an access point operates the CTS-based sleep mode, according to an aspect of the disclosure. Upon starting the process 700 at step 710, the access point sets its transmit power to the lowest level (e.g., 5 dBm) at step 712. Then, the access point sets one of stations associated thereto as a target station, and transmit an RTS frame to the target station at the lowest power level at step 716. When the target station does not respond to the RTS frame at step 720, the access point slightly increases the transmit power level at step 722 and the process 700 loops back to transmitting the RTS frame to the target station at the increased transmit power at step 716.

When it is determined that the target station responses to the RTS frame at 720, the access point determines whether all of the associated stations have been checked as the target station at step 730. When it is determined that one or more associated stations have not been checked at step 730, the access point changes the target station to one of the stations that have not been checked at step 732, and the process 700 moves to set another station as the new target station 714. These steps (e.g., steps 714, 716, 720, 722, 730, 732) can be repeated until the access point receives responses to the RTS frame from all the associated stations. As a result, the transmit power can be increased to an optimum power level at which the RTS frame has been transmitted when all the associated stations have responded thereto.

Once all of the associated stations have been checked as the target station at step 730, the access point transmits a CTS-to-self frame at the optimum power level at step 740. This ensures that the CTS-to-self frame reaches all of the associated stations while preventing the CTS-to-self frame from reaching further than the most distant associated station. For example, in FIG. 1, the first access point 200A transmits the CTS-to-self frame at a sufficient power level to reach all of the associated stations 150A, 150B, 150C, but not sufficient to reach the second access point 200B and/or the fourth station 150D in the second BSS 110B. Upon transmitting the CTS-to-self frame at the optimized power level at step 740, the process terminates at step 750.

In addition to optimizing the transmit power level to minimize the impact on overlapping or neighboring BSSs, an access point may need to leave sufficient available medium time for other devices (such as, e.g., an access point, a station and/or the like) in an overlapping BSS when the devices are within a communication range from the access point. To achieve this, the access point may determine the medium occupancies of the BSSs as respective percentages of the total available medium time. Then, the access point may not stay in a sleep mode longer than the idle time available on the radio frequency channel. For example, when the current medium occupancy of the BSS is 75%, the access point of the BSS may not stay in the sleep mode longer than 25% of the beacon interval.

As mentioned above, another enhancement that can be implemented in an access point is to reduce a memory requirement. For example, an access point can include a smaller memory in order to reduce the physical size and manufacturing costs thereof, which is particularly advantageous for a portable access point. Typically, an access point rarely sends data to an associated station in a sleep mode because, if there is incoming data traffic, the station stays awake until processing of the incoming data traffic is completed. If the station stays in a sleep mode and does not process the incoming data traffic, it may mean that the incoming data traffic is not important to the station and is no longer needed to be buffered. Thus, the access point may reserve a smaller buffer (for example, 2 Kbytes) for each associated station in the sleep mode and may drop excess data traffic when the buffer overflows.

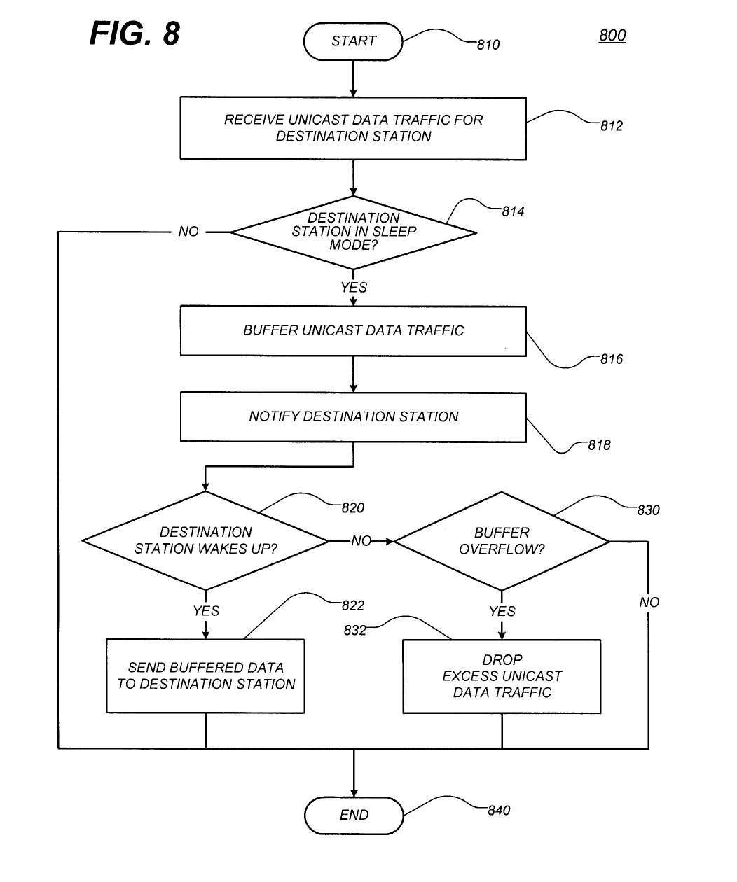

FIG. 8 shows a flow chart of a process 800 for operating an access point to process unicast data traffic for a destination station associated thereto, according to an aspect of the disclosure. After starting the process 800 at step 810, the access point receives unicast data traffic destined for the destination station at step 812. If the destination station is not in a sleep mode at step 814, the process 800 terminates at step 840. If the destination station is in a sleep mode at step 814, the access point buffers the unicast data at step 816 and notifies the destination station of the incoming data therefor at step 818. For example, the access point transmits a DTIM beacon to notify the station of the incoming data traffic. If the destination station reacts positively to the notification at step 820 (e.g., waking up from the sleep mode), the buffered data is sent to the destination station at step 822 and the process 800 terminates at step 840. However, if the destination station reacts negatively (e.g., responding with an instruction not to send the buffered data) or the destination station does not respond (react) to the notification at step 820 (e.g., staying in the sleep mode) and the buffer overflows with the unicast data at step 830, the access point drops the excess unicast data at step 832. The station can react negatively or not respond to the notification at step 820 where, for example, the unicast data is not important to the destination station. When the buffer does not overflow at step 830, the access point keeps buffering the unicast data and the process 800 terminates at step 840. Accordingly, by configuring the access point to drop the excess unicast data in the destination buffer when the buffer overflows, the access point operates normally with a smaller buffer with reduced storage capacity.

With respect to multicast data traffic buffering, an access point buffers all multicast data traffic if any of the destination stations associated thereto is in a sleep mode. The multicast data is delivered to the destination stations after the access point transmits a DTIM beacon. Except for occasional active situations (such as, e.g., multicasting streaming), the multicast data is typically used for non-active situations (e.g., service advertisement, discovery and/or the like). In the non-active situations, an active service or agent generates multicast frames less frequently than once every few seconds. Thus, the access point can be configured to adjust a number of buffers reserved for each destination station depending on a situation, such as, e.g., the active situations, the non-active situation and the like. Particularly, the access point can reserve a smaller number of buffers (e.g., five to ten buffers) for buffering the multicast data for the non-active situations.

The multicast data frames for the non-active situations are typically much shorter than the maximum frame length. Thus, the access point can be configured to adjust the buffer size in order to reduce the overall memory requirement. For example, the access point can store the non-active multicast data frames in, e.g., without limitation, a contiguous FIFO or the like.

The access point can be further configured to buffer overflow multicast data traffic in host memory when all the reserved buffers in device memory become entirely occupied before the DTIM beacon arrives. This may be achieved by, for example, a token passing mechanism between the host and the device. The device may send tokens to the host when the buffers reserved for multicast data traffic during the sleep mode become free. The host may deduct tokens when it sends multicast data frames to the device. The host may limit the multicast data traffic sent to the associated station based upon the number of tokens it currently possesses.

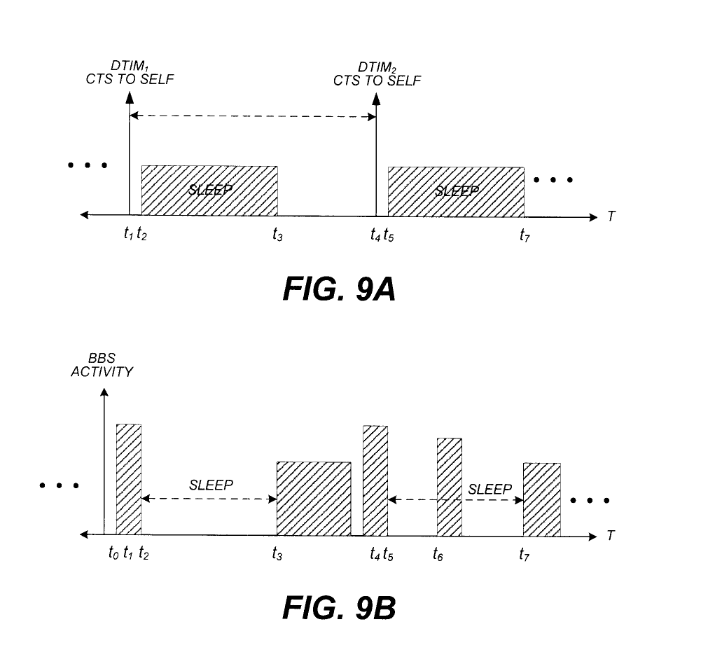

FIG. 9A shows a timing diagram of a periodic sleep mode based on a CTS-to-self frame described in FIG. 5. FIG. 9B shows a time versus BSS activity diagram during the same time period as FIG. 9A. Referring to FIG. 9A, when there is no activity in the BSS, an access point transmits a first DTIM (DTIM₁) to keep the associated stations awake and transmit a CTS-to-self frame at time t₁. Then, the access point enters the sleep mode at time t₂ and stay in the sleep mode for the sleep period between times t₂ and t₃. The sleep duration may be specified in the network allocation vector (NAV) of the CTS-to-self frame or the like. The access point wakes up at time t₃ when the sleep duration lapses. In the mean time, as seen in FIG. 9B, activities may occur in the BSS around time t₁ (e.g., period between times t₀ to t₂) to transmit a DTIM beacon frame, the CTS-to-self frame and/or the like within in the BSS before the access point enters the sleep mode at time t₂. In an ideal situation, no activity should occur in the BSS during the sleep period between times t₂ and t₃. However, some network client devices are configured not to honor a NAV (i.e., sleep duration) larger than 3 ms to, e.g., protect from NAV attacks and/or the like. These devices attempt to communicate with the access point while the access point is inactive or turned off during the sleep period. For example, in FIG. 9A, after transmitting the CTS-to-self frame at time t₄, the access point are deactivated or turned off at time t₅ and stay turned off until the sleep duration lapses at time t₇. However, a station may ignore the sleep duration and attempt to communicate with the access point at time t₆ before the access point is turned on at time t₇. Thus, activities may occur in the BSS while the access point is turned off

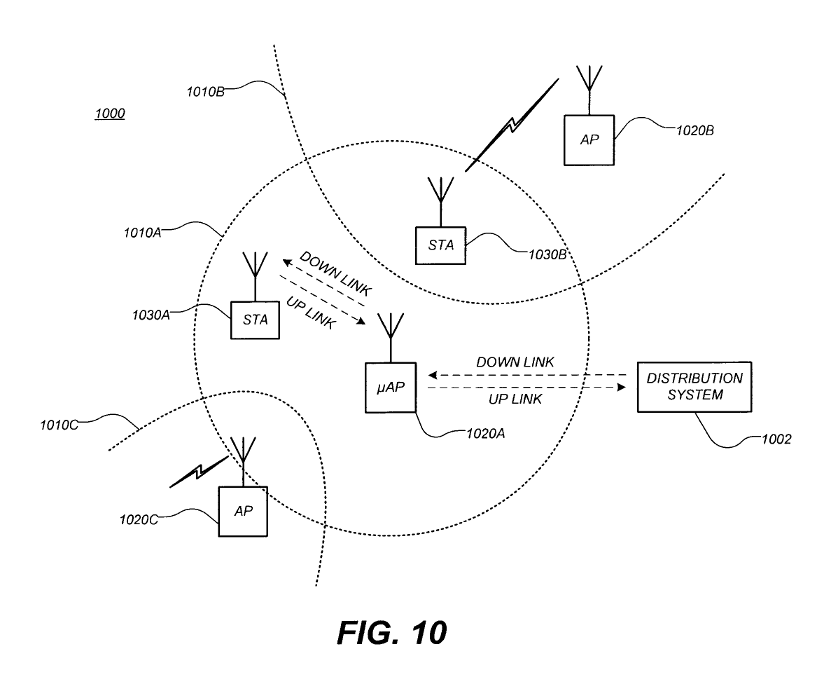

Furthermore, the periodic sleep mode operation can cause jamming in stations and access points in an overlapping BSS. More specifically, FIG. 10 shows a WLAN configuration 1000, including a plurality of BSSs, such as, e.g., a first BSS 1010A, a second BSS 1010B, a third BSS 1010C and/or the like. The first BSS 1010A includes a first access point 1020A, a first station 1030A associated to the access point 1020A and/or the like. The second BSS 1010B includes a second access point 1020B, a second station 1030B associated thereto and/or the like. The third BSS 1010C includes a third access point 1020C and the like.

FIG. 10 particularly shows the second station 1030B being located in an overlapping area between the first BSS 1010A and the second BSS 1010B and the third access point 1020C being within the range of the BSS 1010A. In this case, a CTS-to-self frame broadcast from the first access point 1020A may prevent the devices in the overlapping areas (e.g., the second station 1030B of the second BSS 1010B, the third access point 1020C of the third BSS 1010C and/or the like) from transmitting data to their associated devices during the sleep duration.

The jamming problem becomes more severe when a mobile access point (e.g., portable micro access point, mobile phone-enabled access point or the like) is used to connect stations to a wireless network. The mobile access points are often battery-powered and it is critical to reduce power consumption to provide uninterrupted network connections to the associated stations. However, when a mobile access point is carried to an area overlapping another stationary or mobile BSS, the CTS-to-self frame can cause jamming to the overlapping BSS. The IEEE 802.11 standards currently do not provide any solution for these problems.

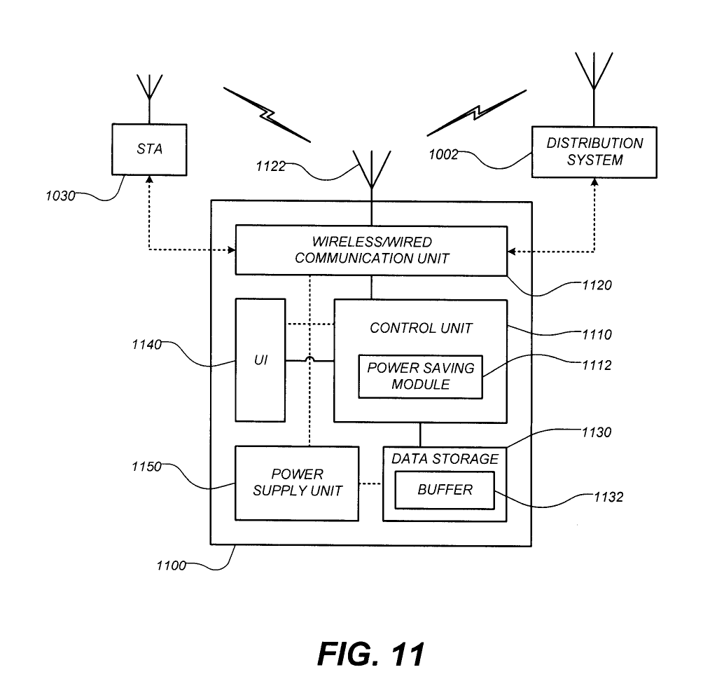

To solve those problems and others, FIG. 11 shows a configuration of an access point 1100 for carrying out a power save operation, constructed according to an aspect of the disclosure. The access point 1100 is a stationary or mobile access point. For example, the access point 1100 is a micro access point, which can be implemented in a mobile phone. The access point 1100 includes a control unit 1110, a wired/wireless communication unit 1120, a data storage unit 1130, a user interface (UI) unit 1140, a power supply unit 1150 and/or the like. The control unit 1110 is configured to control an overall operation of the access point 1100, including operations related to reducing power consumption and/or the like. For example, the control unit 1110 includes a power saving module 1112 to operate the access point 1100 with reduced power consumption. The control unit 1110 may include a microprocessor, a microcontroller, or the like, to execute instructions of a computer program stored in a machine readable storage medium. The instructions may include instructions for carrying out one or more power saving schemes. The control unit 1110 may store the computer program embodying the instructions in its internal data storage (not shown), such as, e.g., an embedded read only memory (ROM), or the like, or, alternatively, in the data storage unit 1130.

The communication unit 1120 exchanges data streams with other devices, such as, e.g., the distribution system 1002 and the station 1030 shown in FIG. 10 and/or the like, via wired connections or wirelessly via an antenna 1122. The data storage unit 1130 temporarily stores data that is sent to and from the station 1030 associated thereto. For example, the data storage unit 1130 includes a buffer 1132 for temporarily storing the data bound to the station 1030, as well as data bound to the access point 1100 from the station 1030. The power supply unit 1150 is connected to the control unit 1110, the communication unit 1120, the data storage unit 1130, the user interface unit 1140 and/or the like, to supply power thereto. The power supply unit 1150 may include a rechargeable battery, a non-rechargeable battery, an array of solar cells, a wired power supply configured to receive power from an external AC or DC power supply source, or the like.

The access point 1100 is configured to perform a comprehensive power consumption management scheme which involves one or more power save operations, such as, e.g., a periodic power save operation, an activity-based power save operation and/or the like. The periodic power save operation can be performed based on the CTS-to-self frame broadcasting as described above. As described below in detail, the activity-based power save operation can be performed without broadcasting a CTS-to-self frame. Further, the comprehensive power save scheme may include operating the access point 1100 in a non-power save mode when necessary. The access point 1100 can be configured to receive via, e.g., the user interface unit 1140, a user input for enabling or disabling a power save operation, selecting a particular power save mode, customizing options, conditions, parameters and/or the like for each power save operation, and/or the like.

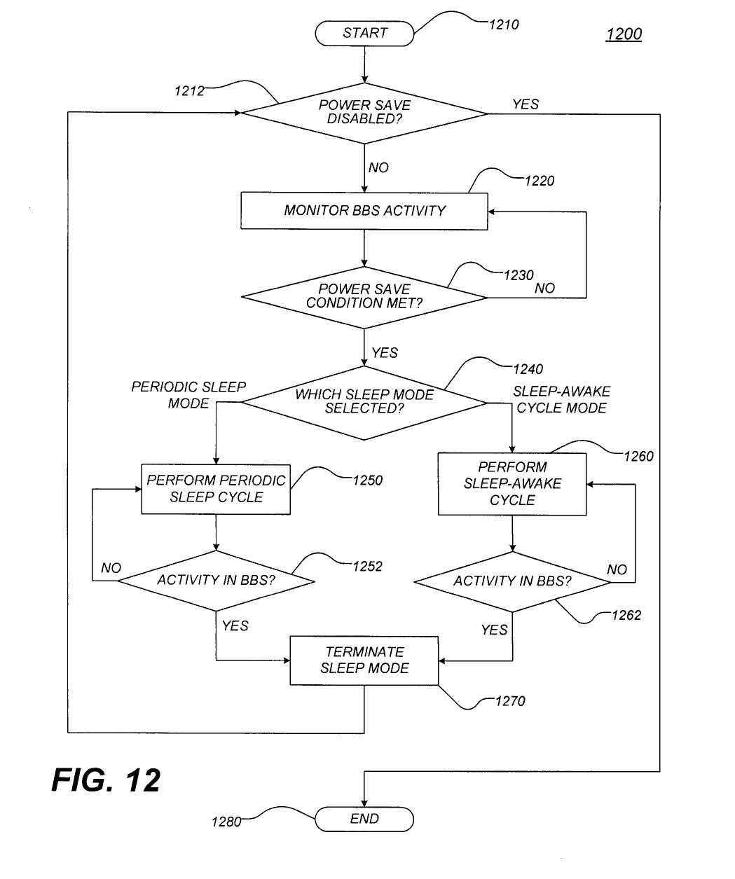

FIG. 12 shows a flow chart of a process 1200 for carrying out a comprehensive power consumption management scheme in an access point, such as, e.g., the access point 1100 shown in FIG. 11, according to an aspect of the disclosure. The process 1200, however, may be performed by different access points having different configurations. Upon starting the process 1200 (at 1210), the control unit 1110 of the access point 1100 checks whether or not a power save function has been disabled (at 1212). As noted above, a user may enable or disable a power save function of the access point via the user interface unit 1140. When the power save operation is disabled (YES at 1212), the process 1200 terminates (at 1280) and the access point 1100 operates in a non-power save mode. When the power save function is not disabled (NO at 1212), the control unit 1110 monitors activities (at 1220) in the BSS 1010 (see FIG. 10) to determine whether a power save condition is satisfied or not (at 1230).

The power save condition may differ depending on how a BSS is constructed and operated. For example, the power save condition can be satisfied when all the media access control (MAC) transmission (TX) rings for unicast frames are empty, a power save (PS) handshake between the access point and a host (e.g., distribution system 1002 shown in FIG. 10) is completed when the host is present, there is a sufficient time (e.g., 10 ms or longer) until a next target beacon transmission time (TBTT), a broadcast PS frame has been transmitted, a broadcast ring is empty and a traffic indication map (TIM) bit is set to zero when a current delivery traffic indication message (DTIM) count is zero, no unicast frame is buffered for any associated station, and/or the like. Since the power save condition can differ from one BSS to another, the power save condition can be satisfied when not all of the above conditions are met. For example, when the host is not present in the BSS, the power save condition can be met even if no PS handshake has been performed between the access point and the host.

When the power save condition is not satisfied (NO at 1230), the control unit 1110 continues to monitor the activities in the BSS 1010 (at 1220). However, when the power save condition is met (YES at 1230), the control unit 1110 determines which sleep mode has been selected (at 1240). As noted above, the control unit 1100 operates the access point 1100 in one of several power save modes, such as, e.g., a periodic sleep mode, a BSS activity-based power save mode and/or the like. Other power save modes are also contemplated. When the periodic sleep mode is selected (at 1240), the control unit 1110 performs the CTS-to-self frame-based power save operation described in FIG. 5 (at 1250). As noted above, the periodic sleep mode can be selected when jamming is not a concern, the stations are configured to honor the NAV transmitted from the access point 1100 and/or the like. While operating in the periodic sleep cycle mode (at 1250), the control unit 1110 monitors activities in the BSS 1010 (at 1252) to determine whether or not to continue the periodic sleep operation. While no activity is observed (NO at 1252), the control unit 1110 continues to operate the access point 1100 in the periodic sleep mode (at 1250). However, when activities are detected (YES at 1252), the control unit 1110 terminates the periodic sleep mode (at 1270) and the process loops back to checking whether or not the power save mode is disabled or enabled (at 1212).

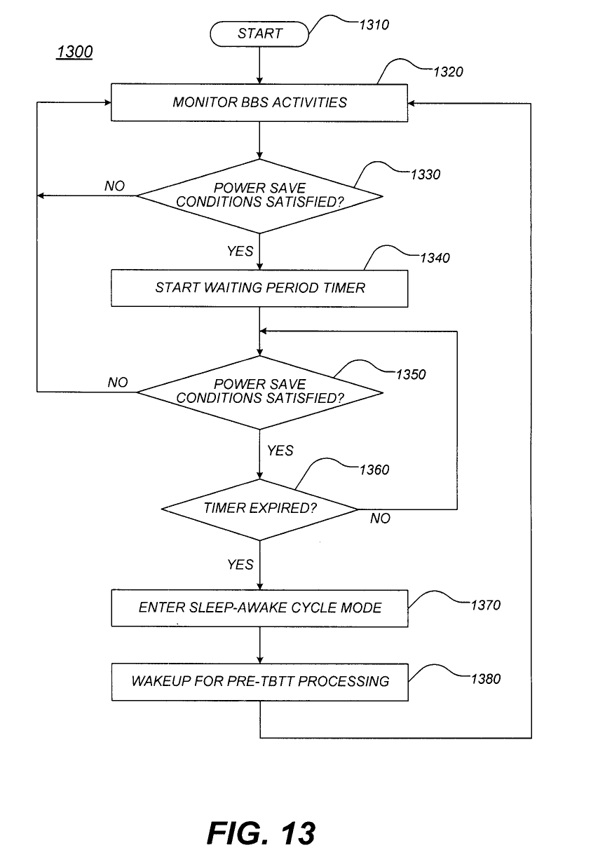

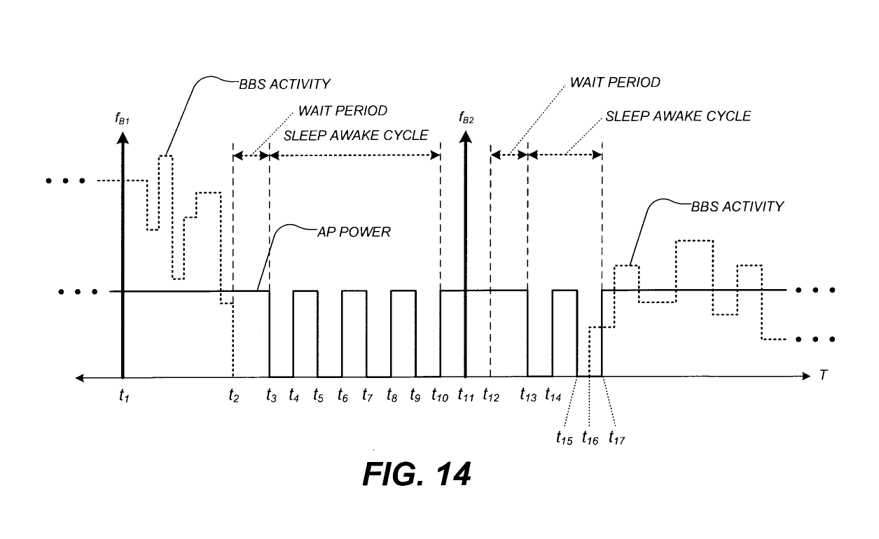

When the sleep-awake cycle mode has been selected (at 1240), the control unit 1110 operates the access point 1100 in the sleep-awake cycle mode, of which an example is described in detail in FIGS. 13 and 14. As noted above, the sleep-awake cycle mode does not require broadcasting a CTS-to-self frame to forcefully stop activities in the BSS 1010 for the sleep period. Thus, a user can select the sleep-awake cycle mode when there is a concern about causing jamming to a neighboring BSS, the NAV being ignored by associated stations and/or the like. During the sleep-awake cycle mode, the control unit 1110 periodically checks whether there is activities in the BSS 1010 (at 1262). The control unit 1110 continues to operate the access point 1100 in the sleep-awake cycle mode (at 1260) when there are no activities (No at 1262). However, when activities are detected in the BSS 1010 (YES at 1262), the control unit 1110 terminates the sleep-awake cycle mode (at 1270) and the process loops back to checking whether the power save mode has been enabled or disabled (at 1212). Although only two sleep modes are described in the process 1200, other sleep modes can be included in the process 1200. For example, the access point 1100 can be configured to perform only one of the periodic sleep mode and the sleep-awake cycle mode when the power save mode is enabled. Further, the access point 1100 can be configured to automatically switch to the optimum power save mode and/or enable or disable the entire power save operation based on the configuration and current activities of the BSS 1010.

FIG. 13 shows a flowchart of a power save process 1300 for an access point based on activities in a BSS according to an aspect of the disclosure. The process 1300 can be performed in connection with other power save operations. For example, as shown in FIG. 12, the process 1300 can be a part of a comprehensive power consumption management scheme for an access point. Alternatively, an access point can be configured to perform the process 1300 only or to switch between a non-power save mode and the process 1300. Accordingly, the process 1300 can be entirely or partially implemented in various ways, and, hence, is not be limited to the specific steps arranged in a specific order shown in FIG. 13.

Upon starting the process 1300 (at 1310), an access point operates in a normal non-power save mode while monitoring activities in a BSS (at 1320) to determine whether or not a power save condition is satisfied in the BSS (at 1330). As mentioned above, the power save condition can be satisfied, for example, when all the MAC TX rings for unicast frames are empty, a PS handshake between the access point and a host (e.g., distribution system 1002 shown in FIG. 10) is completed when the host is present, there is a sufficient time (e.g., 10 ms or longer) until a next TBTT, a broadcast PS frame has been transmitted, a broadcast ring is empty and a TIM bit is set to zero when a current DTIM count is zero, no unicast frame is buffered for the station, and the like.

When the power save condition is not satisfied (NO at 1330), the access point continues to operate in the non-power save mode while monitoring the activities in the BSS. When the power save condition is met (YES at 1330) during the non-power save mode, the access point does not enter a power save mode immediately. Instead, the access point operates in a pre-power save mode and delays entering the power save mode for a predetermined period of time (i.e., waiting period) while continuing to monitor activities in the BSS. The waiting period can be customized. For example, an access point can be configured to receive user input to adjust the waiting period via a user interface, such as, e.g., the user interface unit 1140 shown in FIG. 11. The waiting period, however, is not longer than a DTIM beacon transmission interval to prevent the access point from skipping beacon transmissions. The waiting period can be shortened for more power saving or lengthened for better performance.

Considering the amount of data downloaded to a station via an access point is usually significantly larger than the uploaded data moving in the opposite direction, once data (e.g., web pages, emails and/or the like) is downloaded to a station (e.g., a PC, mobile phone or the like), the station may not cause any activities in the BSS for a period because, for example, the user of the station may be reading a web page or email. The process 1300 can take advantage of this inactivity period to reduce power consumption by operating the access in a power save mode. However, the overall performance of the BSS can be deteriorated when the access point enters a power save mode as soon as the power save condition is met and fails to handle activities (e.g., requests from stations and/or the like) occurring shortly after the power save condition is met. By operating in the pre-power save mode for a waiting period, the access point can respond to activities that occur shortly after the power save condition is met. Thus, compared to other power saving operations, the process 1300 can reduce power consumption while having less impact on the BSS performance.

The access point enters the power save mode when the power save condition is continuously satisfied for the entire waiting period. For example, when the power save condition is satisfied (YES at 1330), the access point starts a waiting period timer (at 1340) and continue to monitor the BSS activities to determine whether or not the power save condition is continuously satisfied (at 1350) until the waiting period timer expires. When the power save condition is not satisfied due to an activity in the BSS (NO at 1350) before the timer expires (No at 1360), the access point does not enter the power save mode and the process loops back to monitoring the BSS activities (at 1320). However, when the power save condition is satisfied (YES at 1350) for the duration of the timer (YES at 1360), the access point enters a sleep-awake cycle mode for power save (at 1370), which is described in detail in FIG. 14. The sleep-awake cycle mode can also be customizable. The access point then wakes up in time (sufficiently prior) for pre-target beacon transmission time (TBTT) processing (at 1380) and the process starts over from the BSS activity monitoring (at 1320).

Additionally, the access point can be configured to restart the waiting period timer without starting over from the beginning (at 1310) when a power save resume condition is satisfied. For example, when activities are detected during the sleep-awake cycle mode, the access point terminates the sleep-awake cycle mode and check whether the power save resume condition is satisfied. The power save resume condition can be met when at least one of a non-null data packet is received, a management packet received, a PS poll message is received, a data packet is received from the host, a transmission of packets queued in a media MAC TX ring is completed except for a beacon frame, a probe response frame and an acknowledgement (ACK) frame, the waiting period timer has expired but at least one of a MAC unicast ring and a multicast ring is not empty, and a unicast packet for the station is added to a power save queue and the like. When the power save resume condition is satisfied, the access point immediately resumes the sleep-awake cycle mode.

FIG. 14 shows a timing diagram of the power save process 1300 shown in FIG. 13 according to an aspect of the disclosure. FIG. 14 particularly shows the access point adjusting its power consumption in response to activities in the BSS. Initially, the access point consumes power at time t₁ to carry out required operations to maintain the connection between the access point and the station in the BSS, such as, e.g., broadcasting a first beacon frame f_{B1} and/or the like. Further, the access point 1100 needs to consume power to handle the BSS activities. Thus, the power save condition would not be satisfied at least until there is no BSS activities at time t₂. As noted above, the access point does not enter the power save mode immediately even though the power save condition is met at time t₂. Instead, the access point operates in a pre-power save mode for a waiting period between times t₂ and t₃ to monitor activities in the BSS. During the waiting period, the access point continues to consume power for, e.g., BSS activity monitoring and/or the like. The access point enters the power save mode at time t₃ since no activity occurs during the waiting period.

During the power save mode, the access point performs a sleep-awake cycle to reduce power consumption. For example, as shown in FIG. 14, the access point is turned off at times t₃, t₅, t₇ and t₉ and turned on at t₄, t₆, t₈ and t₁₀. Thus, the access point is turned on for periods (i.e., on (awake) periods) between times t₄ and t₅, times t₆ and t₇, times t₈ and t₉ and times t₉ and t₁₀, and turned off for the periods (i.e., off (sleep) periods) between times t₃ and t₄, times t₅ and t₆ and times t₇ and t₈. In other words, the off periods and on periods are arranged alternatively. Durations of the off periods and on periods can also be customized. For example, the user may adjust the durations of the on and off periods via a user interface of the access point. Further, it may be possible to set the duration of the off periods longer than that of the on period and vice versa. Further, the durations of the on and off periods in the early stage of the sleep mode may be shorter than those in the later stage thereof and vice versa. During the on periods, the access point monitors activities in the BSS and switches to a non-power save mode when activities are detected. By setting the off period to be substantially short, the access point can wake up from the sleep mode immediately even when activates occur during an off period. Accordingly, the sleep-awake cycle can be customized, for example, to optimize the balance between performance and power consumption, to reduce power consumption by lengthening the off period duration, to increase performance by lengthening the on period duration or the like.

The access point terminates the sleep-awake cycle at time t₁₀ for the pre-TBTT processing and broadcast a second beacon frame f_{B2} at time t₁₁. Upon detecting that there are no activities in the BSS at time t₁₂ and the power save condition is satisfied, the access point operates in the pre-power save mode and continue to monitor the BSS activities for the waiting period between times t₁₂ and t₁₃. When no activities are detected for the entire waiting period, the access point starts the sleep-awake cycle at time t₁₃. More specifically, the access point is turned off during a first off period between times t₁₃ and t₁₄ and turned on during a first on period between times t₁₄ and t₁₅. During the first on period, the access point checks if there are any activities in the BSS. Upon confirming that there are no BSS activities, the access point is turned off for a second off period between times t₁₅ and t₁₇. When an activity occurs at time t₁₆, the access point is in the second off period and hence cannot respond to the activity. However, when the access point is turned on at time t₁₇ to start a second on period, the activity is detected and the access point terminates the sleep-awake cycle and operates in a non-power save mode to handle the activities. Additionally, as noted above, after terminating the sleep-awake cycle at time t₁₇, the access point resumes the sleep-awake cycle when the power save resume condition is satisfied at some later time.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

1. An activity-based power saving method for an access point configured to connect a station to a wireless network, the method comprising:
operating the access point in a non-power save mode;
monitoring an activity in a basic service set of the access point while the access point operates in the non-power save mode;
switching operation of the access point from the non-power save mode to a pre-power save mode in response to the activity in the basic service set satisfying a first pre-determined condition while the access point operates in the non-power save mode, wherein switching operation of the access point from the non-power save mode to the pre-power save mode is performed without the access point going to sleep;
monitoring the activity in the basic service set while the access point operates in the pre-power save mode;
switching operation of the access point from the pre-power save mode to the non-power save mode in response to activity in the basic service set not continuously satisfying the first pre-determined condition while the access point operates in the pre-power save mode, wherein switching operation of the access point from the pre-power save mode to the non-power save mode is performed without the access point going to sleep; and
switching operation of the access point from the pre-power save mode to a power save mode in response to the activity in the basic service set continuously satisfying the first pre-determined condition while the access point operates in the pre-power save mode.

2. (canceled)

3. The method of claim 1, wherein the first pre-determined condition comprises at least one of:
a media access control (MAC) transmission (TX) ring for a unicast frame is empty;
a power save handshake between the access point and a host has been completed;
a sufficient time remains to a next target beacon transmission time (TBTT);
broadcast power save frames have been transmitted, a broadcast ring is empty and a traffic indication map (TIM) bit is set to zero when a current delivery traffic indication message (DTIM) count is zero; and
no unicast frame has been buffered for the station.

4. The method of claim 1, wherein switching operation of the access point from the non-power save mode to the pre-power save mode comprises:
starting a timer in response to the first pre-determined condition being satisfied while the access point operates in the non-power save mode; and
monitoring the activity in the basic service set during a time period measured using the timer.

5. (canceled)

6. The method of claim 4, wherein operating the access point in the power save mode comprises:
performing a sleep-awake cycle wherein the sleep-awake cycle comprises at least one sleep period and at least one awake period operated alternatingly.

7. The method of claim 6, further comprising:
monitoring the activity in the basic service set during each awake period; and
switching operation of the access point to the non-power save mode in response to the first pre-determined condition not being satisfied during a given awake period.

8. The method of claim 7, further comprising:
restarting the timer in response to a second pre-determined condition being satisfied, the second pre-determined condition comprising at least one of:
a non-null data packet having been received by the access point;
a management packet having been received by the access point;
a power save (PS) poll message having been received by the access point;
a data packet from the host having been received by the access point;
a transmission of packets queued in a media access control (MAC) transmission (TX) ring having been completed except for a beacon frame, a probe response frame and an acknowledgement (ACK) frame;
the timer having expired, and at least one of a MAC unicast ring and a multicast ring is not empty; and
a unicast packet for the station having been added to a power save queue.

9. The method of claim 7, further comprising:
receiving a user input to set at least one of (i) the duration of the timer, (ii) the sleep period, and (iii) the awake period.

10. The method of claim 1, further comprising:
performing, in response to determining whether power save is enabled in the access point, at least one of:
the method of claim 1;
a Clear-To-Send-To-Self frame-based power saving operation; and
no power saving operation.

11. An access point configured corresponding to a basic service set, comprising:
a wireless communication unit configured to communicate with a wireless communication device in the basic service set; and
a processor configured to execute machine readable instructions that, when executed by the processor, cause the processor to
perform a power save operation based on an activity in the basic service set,
operate the access point in a non-power save mode when a first pre-determined condition is not satisfied in the basic service set,
switch operation of the access point from the non-power save mode to a pre-power save mode when the activity in the basic service set satisfies the first pre-determined condition while the access point operates in the non-power save mode, wherein switching operation of the access point from the non-power save mode to the pre-power save mode is performed without the access point going to sleep,
switch operation of the access point from the pre-power save mode to the non-power save mode in response to activity in the basic service set not continuously satisfying the pre-determined condition while the access point operates in the pre-power save mode, wherein switching operation of the access point from the pre-power save mode to the non-power save mode is performed without the access point going to sleep, and
switch operation of the access point from the pre-power save mode to a power save mode when the activity in the basic service set continuously satisfies the first pre-determined condition while the access point operates in the pre-power save mode.

12. (canceled)

13. The access point of claim 11, wherein the first pre-determined condition comprises:
a media access control (MAC) transmission (TX) ring for a unicast frame is empty;
a power save handshake between the access point and a host has been completed;
a sufficient time remains to a next target beacon transmission time (TBTT);
broadcast power save frames have been transmitted, a broadcast ring is empty and a traffic indication map (TIM) bit is set to zero when a current delivery traffic indication message (DTIM) count is zero; and
no unicast frame has been buffered for the wireless communication device.

14. The access point of claim 11, wherein the machine readable instructions, when executed by the processor, further cause the processor to start a timer when the first pre-determined condition is satisfied while the access point operates in the non-power save mode.

15. (canceled)

16. The access point of claim 14, wherein the machine readable instructions, when executed by the processor, further cause the processor to perform a sleep-awake cycle in the power save mode, wherein the sleep-awake cycle comprises at least one sleep period and at least one awake period operated alternatingly.

17. The access point of claim 16, wherein the machine readable instructions, when executed by the processor, further cause the processor to i) monitor the activity in the basic service set during each awake period and ii) switch operation of the access point from the power save mode to the non-power save mode when the first pre-determined power condition is not satisfied during a given awake period.

18. The access point of claim 17, wherein the machine readable instructions, when executed by the processor, further cause the processor to restart the timer when a second pre-determined condition is satisfied, the second pre-determined condition comprising at least one of:
a non-null data packet having been received by the access point;
a management packet having been received by the access point;
a PS poll message having been received by the access point;
a data packet from the host having been received by the access point;
a transmission of packets queued in a MAC TX ring having been completed except for a beacon frame, a probe response frame and an acknowledgement (ACK) frame;
the timer having expired, and at least one of a MAC unicast ring and a multicast ring being not empty; and
a unicast packet for the wireless communication device having been added to a power save queue.

19. The access point of claim 16, further comprising:
a user interface configured to receive a user input to set at least one of (i) durations of the timer, (ii) the awake period, and (iii) the sleep period.

20. The access point of claim 11, wherein the machine readable instructions, when executed by the processor, further cause the processor to operate the access point in at least one of:
the power save operation based on the activity in the basic service set;
a Clear-To-Send-To-Self frame-based power save mode; and
a non-power save mode.

21. The access point of claim 11, further comprising:
a memory device that stores the machine readable instructions.

22. The method of claim 4, wherein switching operation of the access point from the pre-power save mode to the non-power save mode comprises switching operation of the access point from the pre-power save mode to the non-power save mode prior to the end of the time period.

23. The access point of claim 14, wherein the machine readable instructions, when executed by the processor, further cause the processor to switch operation of the access point from the pre-power save mode to the non-power save mode prior to an end of a time period measured by the timer.
